(19) United States
(12) Patent Application Publication
(10) Pub. No.: US 2024/0246326 A1
(43) Pub. Date: Jul. 25, 2024

(54) ALTERNATING STAGGERED LAYER CORE INSULATING PANEL AND METHOD OF MAKING SAME

(71) Applicant: tForm, Inc., Greenville, SC (US)

(72) Inventors: Benjamin Edward Lee Moore, Central, SC (US); Wesley Robert Johnson, Greenville, SC (US)

(21) Appl. No.: 18/417,696

(22) Filed: Jan. 19, 2024

Related U.S. Application Data
(60) Provisional application No. 63/480,925, filed on Jan. 20, 2023.

(51) Int. Cl. B32B 29/00; B32B 3/30; B32B 7/12; B32B 29/08; B32B 37/12; B32B 37/18; B32B 38/00; B65D 65/40

(52) U.S. Cl. CPC B32B 29/005; B32B 3/30; B32B 7/12; B32B 29/08; B32B 37/12; B32B 37/18; B32B 38/0012; B65D 65/403; B32B 2255/12; B32B 2255/26; B32B 2317/127; B32B 2553/00

(57) ABSTRACT

The disclosed embodiments relate to an insulative protective packaging panel constructed using recyclable and biodegradable materials. The insulating panel can include an outer shell and a core material constructed of paper. The core can include a paper sheet or a plurality of paper sheets with a plurality of protrusions formed in an alternating pattern out of the plane of a surface the paper. The paper sheet or sheets are folded in an undulating staggered pattern to create an alternating staggered layer structure. The layered structure core is adhered to the outer shell. The resulting structure is an insulating packaging panel that can be easily recycled.

### CROSS-REFERENCE TO RELATED APPLICATION(S)

This application claims the benefit of U.S. provisional patent application no. 63/480,925, filed on Jan. 20, 2023, which is incorporated by reference herein in its entirety.

### TECHNICAL FIELD

The disclosed teachings relate to a packaging product. More specifically, the disclosed teachings relate to an insulative, protective, and recyclable packaging panel.

### BACKGROUND

Demand for packaging materials has increased dramatically with the growing popularity of e-commerce websites that ship individually packaged items. Additionally, demand for shipping temperature-sensitive items such as foods and beverages directly to an end-consumer has also increased substantially. Shipping temperature-sensitive items directly to end-consumers creates unique challenges for the shipper as to ensure that the products arrive either at a refrigerated or frozen temperature. Typically these shippers will utilize a corrugated box containing an insulating panel or panels, the consumer's desired product, and some form of phase change material such as dry ice or ice packs to maintain the desired temperature during transit.

In addition to the increased demand for shipping temperature-sensitive items, consumers are changing their preferences and perspectives of purchasing items which are considered to be environmentally responsible. This change in preference has also extended into the type of packaging used to ship their desired products.

### BRIEF DESCRIPTION OF THE DRAWINGS

FIG. 1 is an isometric view of protrusions formed into Pattern ‘A’ into a ply of paper followed by a flat Pattern ‘B’ to create an alternating pattern.

FIG. 2 is an isometric view of an indentation formed at the trailing edge of Pattern ‘A’ to promote folding.

FIG. 3 is a side view of a folded alternating pattern ply to create a core structure.

FIG. 4 is a side view of a core structure with outer shell layers attached.

FIG. 5 is an isometric view of an encapsulated insulating panel.

FIG. 6 is an isometric view of formed protrusions in Pattern ‘A’ followed by a different geometry of formed protrusions in Pattern ‘B’.

FIG. 7 is an isometric view of formed protrusions in Pattern ‘A’ followed by a different geometry of formed protrusions in Pattern ‘B’.

FIG. 8 is an isometric view of multiple layers stacked parallel to the plane of the insulating liner to create a core.

FIG. 9 is an isometric view of an insulating panel with a separate outer shell piece attached to the sides of the panel.

FIG. 10 is an isometric view of an insulating panel with a separate outer shell piece attached to the ends of the panel.

FIG. 11 is an isometric view of formed protrusions in Pattern ‘A’ followed by different geometry in Pattern ‘B’ followed by different geometry in Pattern ‘C’ followed by different geometry in Pattern ‘D’.

FIG. 12 is a side view of multiple layers stacked parallel to the plane of the insulating liner to create a core.

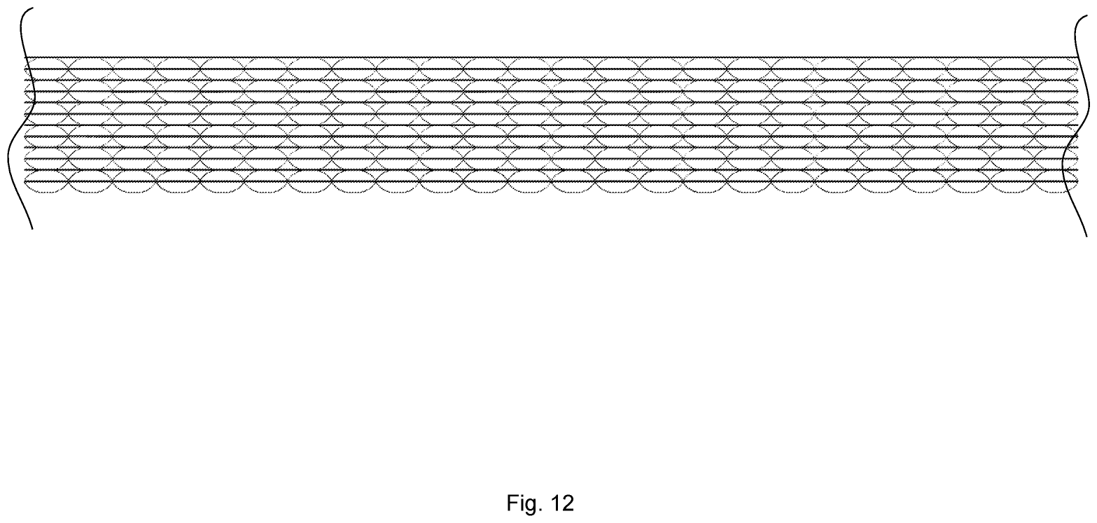

FIG. 13 is a side view of non-planar layers stacked to create a non-planar core structure.

FIG. 14 is an isometric cross-sectional view of a non-planar core structure.

FIG. 15 is a side view of multiple core structures adjacent to one another to create an insulating panel.

FIG. 16 is an isometric view of multiple core structures adjacent to one another to create an insulating panel.

FIG. 17 is an isometric view of an insulating panel where the outer shell does not extend beyond the core structure.

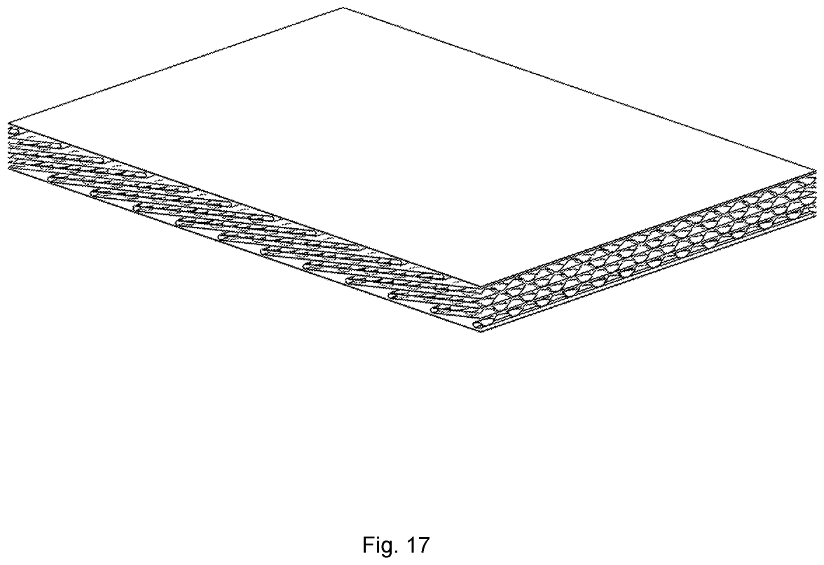

FIG. 18 is an isometric view of an insulating panel with varying thickness along the width and length axes.

FIG. 19 is an isometric cross-sectional view of the insulating panel of FIG. 18.

FIG. 20 is an isometric view of a method for assembling a core structure from various patterns which are parallel to the insulating panel surface.

FIG. 21 is a side view of a core structure made from various patterns which are parallel to the insulating panel surface.

FIG. 22 is a cross-sectional view of a core structure made from various patterns which are parallel to the insulating panel surface.

FIG. 23 is an isometric view of a core structure made from various patterns which are parallel to the insulating panel surface where the patterns are formed from a continuous ply of material.

FIG. 24 is a side view of the core structure from FIG. 23.

FIG. 25 is a side view of a process to assemble the core structure from a single ply of paper.

FIG. 26 is side view of a process to adhere outer shell layers to a core structure.

FIG. 27 is a side view of a process to make a complete insulating panel containing an alternating staggered layer core structure.

FIG. 28 is a side view of a process to assemble an insulating panel with rollers which assist in guiding the ply for the core structure.

FIG. 29 is an isometric view of an insulating panel formed into a shape to be placed in a shipping container.

FIG. 30 is a side view of the insulating panel from FIG. 29.

FIG. 31 is an isometric view of a non-planar insulating panel.

FIG. 32 is a side view of a non-planar insulating panel.

FIG. 33 is a table of ratios and thickness for typical core structures.

### DETAILED DESCRIPTION

Packaging is the science, art, and technology of enclosing and/or protecting products for distribution, storage, sale, and/or use. Packaging can also be described as a coordinated system of preparing goods for transport, warehousing, logistics, sale, and/or end use. The objectives of packaging are generally known: physical protection (e.g., from mechanical shock, vibration, and the environment), containment, marketing, security, convenience, and portion control.

For insulating panels used within cold-chain or temperature sensitive shipping, there are more specific requirements. The typical packaging system for a temperature-controlled shipment consists of a corrugated box, an insulated panel or panels, the items desired by the customer (‘payload’), and a phase change material such as dry ice or cold packs. There is a specific temperature threshold which must not be exceeded for the items to arrive to the customer in the desired condition. To achieve this the packaging system must have enough phase change material, with enough insulating properties to meet the temperature requirement. Current insulating panels or containers such as styrofoam, cornstarch, denim, and PET staple fiber have been designed to achieve this target in an economical way.

An increasingly important requirement of packaging is that it be environmentally responsible. Consumers consider items to be environmentally responsible based on their perceptions of a product's defining characteristics. This includes, but is not limited to, recyclability, biodegradability, natural resource use, and use of recycled materials. The type of materials used and the construction methods of packaging, and specifically insulating shipping panels significantly affects the packaging's recyclability. The packaging's recyclability relates to how well it can be recovered and processed into raw materials to be used in another product, versus how much of the product will be discarded, entering into a landfill or body of water.

A critical step of the recovery process relates to how easily the end user can dispatch the product to enter the recycling process. In an ideal state, the consumer has a specific recycling bin which is frequently retrieved by a municipality to transport the discarded product to the material recovery facility (MRF) to easily begin the recycling process. This bin segregates the recyclable material from other waste which must be disposed of in the landfill. The MRF is then able to easily sort the recyclable material to be sold or transferred to a facility or third party to convert the material into usable raw goods for new products.

A common issue with this recovery process is that many packaging materials are marketed as recyclable to consumers, yet are not easily recyclable or recoverable by the MRF. A primary example of this is flexible films such as plastic wrap, denim or PET staple fiber. Packaging made with these materials are deficient in that they may be marketed or understood by the general consumer to be recyclable, when in fact they are being placed in the landfill by the MRF without the consumer's knowledge.

An ideal example of recoverable and recyclable materials are corrugated boxes and paper products. These products can be easily identified within the MRF and transferred to a facility which typically can convert the recycled material into corrugated boxes or other paper products. This conversion process typically involves shredding the paper material into smaller pieces and then introducing water also known as a pulping process. If there are other components in addition to paper, for example, a plastic coating or adhesive, these components must easily detach from the paper to be removed from the process or they must break down into small enough pieces to exit into the wastewater stream. Industry-standard ratios exist for percent paper content within a packaging item for it to meet recyclability and repulpability guidelines, but it is known that a higher percentage of paper results in a more environmentally responsible packaging solution. Current state of the art insulating panels which contain proportionally greater than 80% cornstarch material by mass with a paper outer shell are deficient in that when placed in the repulping process, a significant portion of the product exits into the wastewater stream, resulting in a lower percent of material recovered versus discarded material into the environment.

If products which are designed to be easily recyclable in common recycling streams do not reach their intended recycling channel and end up discarded in the landfill, ocean, or other area, having biodegradable properties would improve the level of environmental responsibility. A biodegradable product is one which is capable of being decomposed by bacteria or other living organisms. An example of a biodegradable product is paper. Another example of biodegradable products are bio-plastic coatings and adhesives.

The embodiments introduced here overcome these drawbacks of insulating panels by meeting the general requirements of packaging and the specific requirements of temperature-controlled shipping, while possessing a significantly improved proportional amount of recoverable and recyclable material and also requiring no disassembly or intervention by the end-consumer to enter the recycling stream.

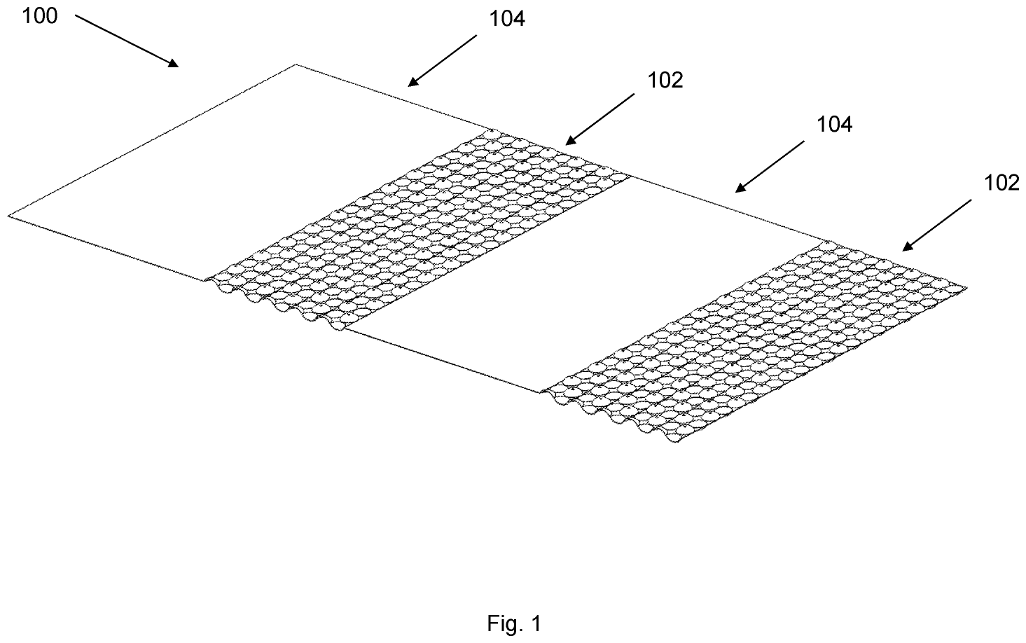

In some embodiments the panel is made of a core composed of one or more plies of either continuous or segmented paper. The ply(s) can include multiple protrusions extending normal to the plane in either one or both directions of the ply to form structural elements which can improve the rigidity of the ply and also increase the effective thickness of the ply. Each of the protrusions includes at least some empty volume. In some embodiments, the pattern of protrusions in the ply is varied along the length of the ply, alternating between an ‘A’ pattern, and ‘B’ pattern either in a sequence indefinitely or in a random configuration until the desired length is reached. The length of the ‘A’ and ‘B’ pattern can be of either equal or unequal length, creating a length ratio of A to B. In some embodiments the pattern may not have any protrusions formed in it at all, leaving a flat ply of unformed paper. As an example, FIG. 1 illustrates the single ply 100, with multiple protrusions formed in Pattern ‘A’ 102, followed by an unformed section in Pattern ‘B’ 104.

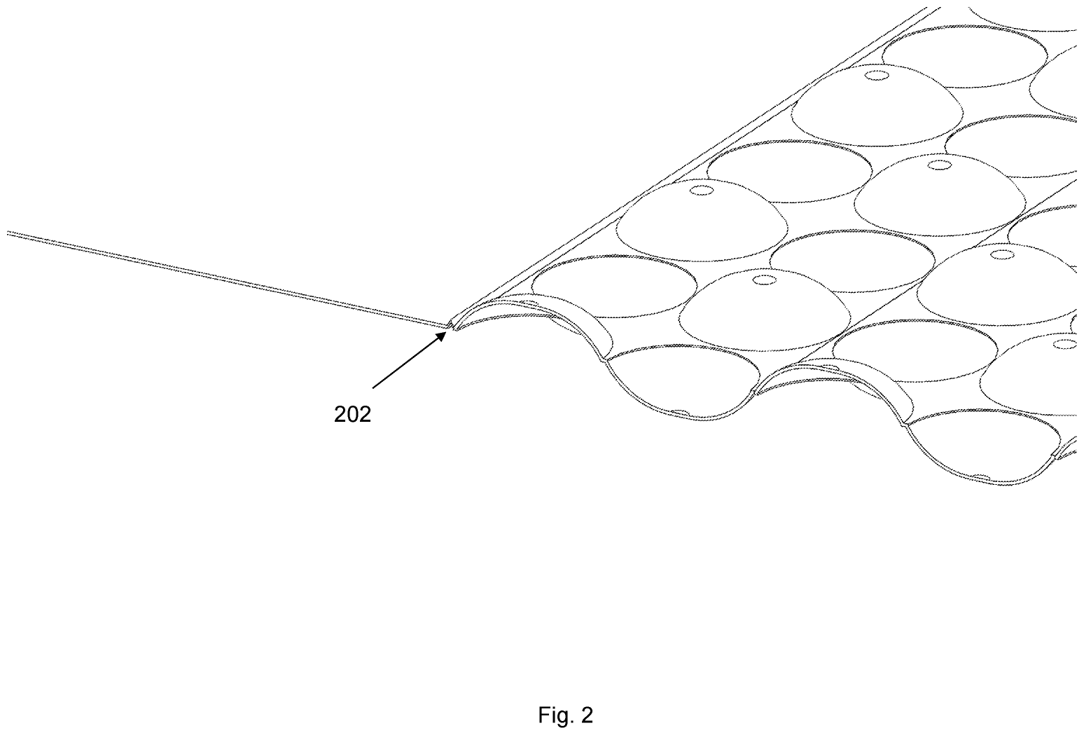

In some embodiments, the alternating patterns formed into the ply(s) are separated by a formation including an indentation, such as indentation 202 shown in FIG. 2, which can act as a hinge to promote the folding of the alternating patterns at their interface. The direction of the protrusion of the hinge feature may alternate at the trailing edges of Pattern ‘A’ and Pattern ‘B’ to promote folding in alternating directions. The ply of paper with the alternating formed patterns is then folded in an undulating pattern (e.g., folded back on itself repeatedly in an accordion-like manner) to create a core structure of greater thickness than the unfolded ply. The folding may be achieved in either the transverse direction or in the longitudinal direction (along the length of the insulating panel).

In some embodiments a hinge is formed into the ply(s) of core paper after the protrusions are formed into the ply(s). In some embodiments the hinge is created from the core structure being folded by mechanical means.

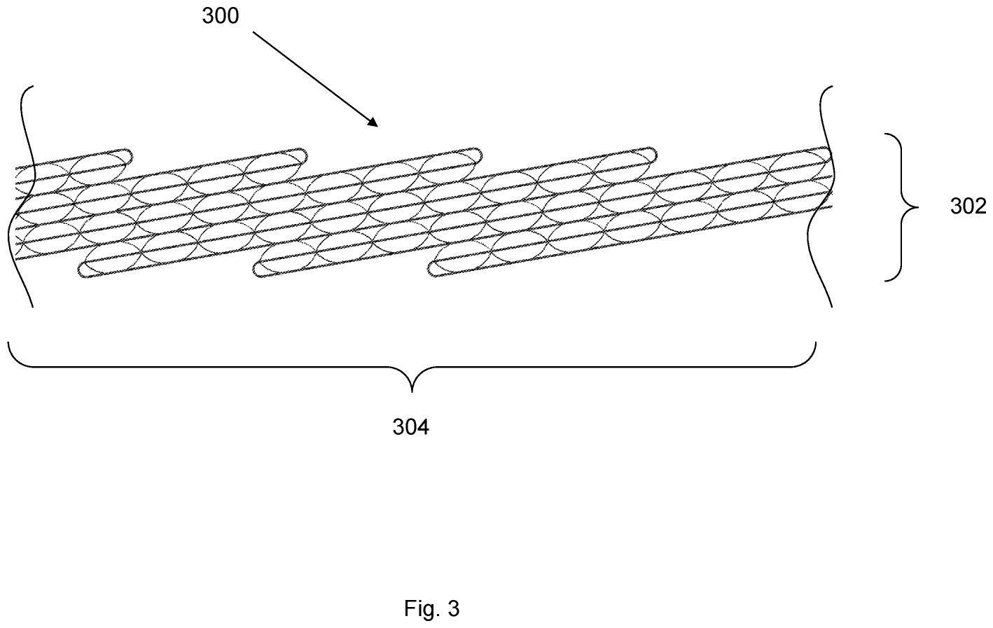

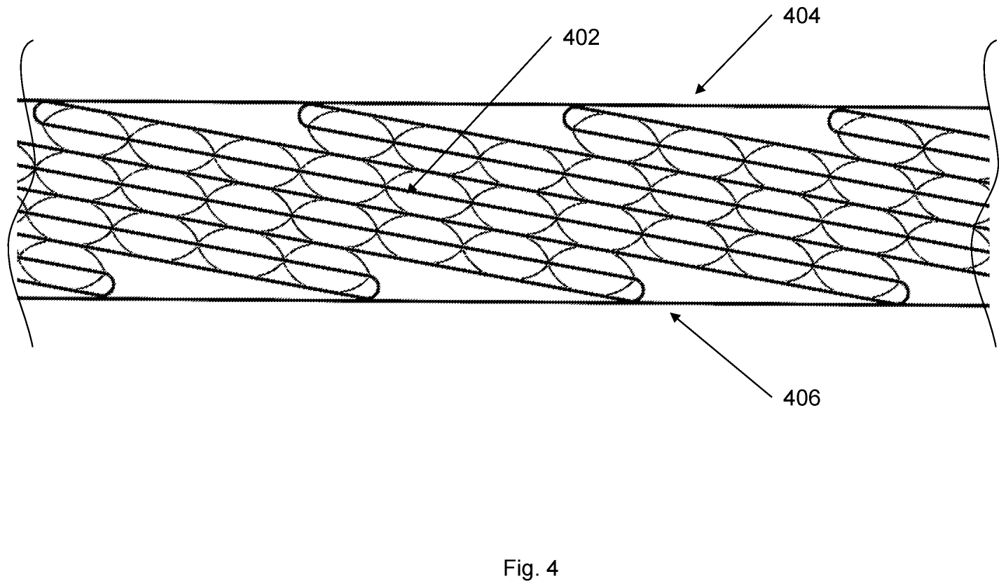

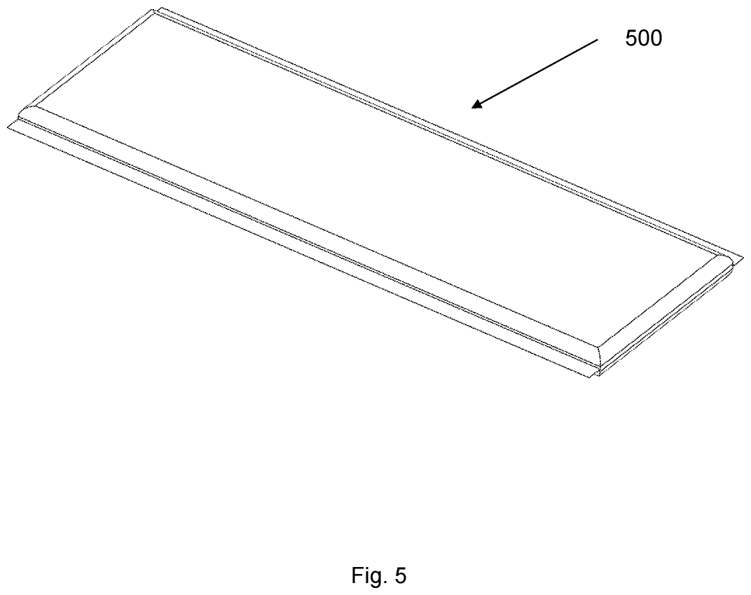

In some embodiments, where the A and B patterns of are unequal length, i.e., where the A:B ratio is not equal to 1, the folding of the paper ply is done in a staggered manner, that is to create a thickness of a core structure which is greater than the paper ply but extends the core section in length at a consistent thickness. “Staggered” in this context means that at least some of the fold lines in a given folding direction (e.g., left-to-right or right-to-left) are not aligned with each other vertically (i.e., in the direction of the core structure's overall thickness). As an example, FIG. 3 shows a core structure 300, consisting of a ply of paper with alternating formed patterns of unequal length folded in a staggered manner. The resulting structure has a thickness 302 greater than the thickness of the formed pattern of the ply of paper, and with a length 304, greater than the length of the A or B patterns. The core structure is then attached to an outer shell composed of one or more plies of paper via an adhesive to maintain the core structure's shape and position. FIG. 4 depicts the core structure 402 attached to an upper outer shell ply 404, and a lower outer shell ply 406. In some embodiments, the outer shell plies may be wider and/or longer than the core structure to allow them to fully encapsulate the core structure to comprise a fully assembled insulating panel as shown in FIG. 5.

In at least some embodiments, each ply is substantially planar (flat) in form, at least when viewed at a macro level, such that each ply has essentially only two surfaces, i.e., a top surface and a bottom surface. More precisely, the thickness of the ply is negligible compared to the surface area of the top surface or the bottom surface. The top surface and/or bottom surface of a ply define “the plane of” the ply. Further, “the surface” of a ply means either the top surface or the bottom surface of the ply, unless otherwise stated herein. Additionally, in at least some embodiments, an insulating panel that comprises one or more plies is also substantially planar in form, viewed at a macro level, where the top surface and/or bottom surface of the insulating panel define “the plane of” the insulating panel, and “the surface” of an insulating panel means either the top surface or the bottom surface of the insulating panel, unless otherwise stated herein.

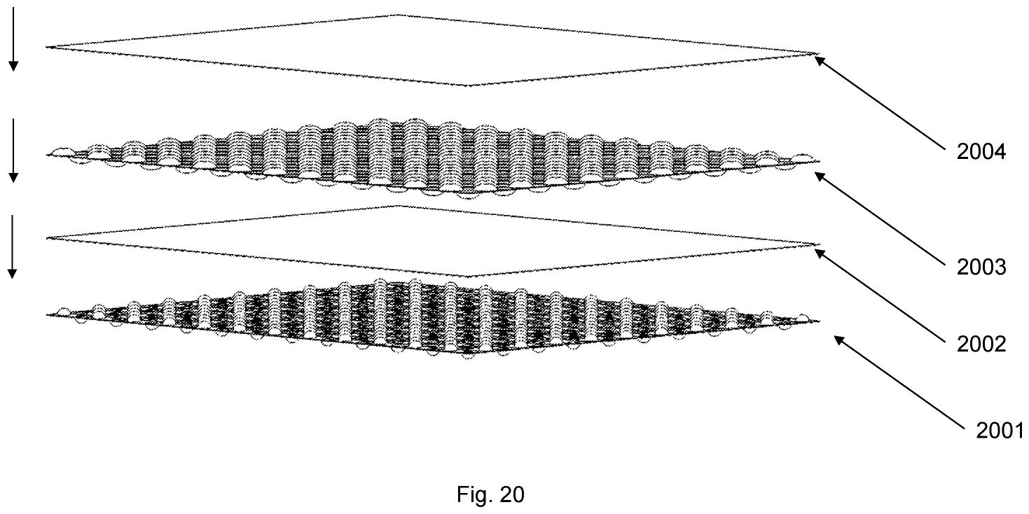

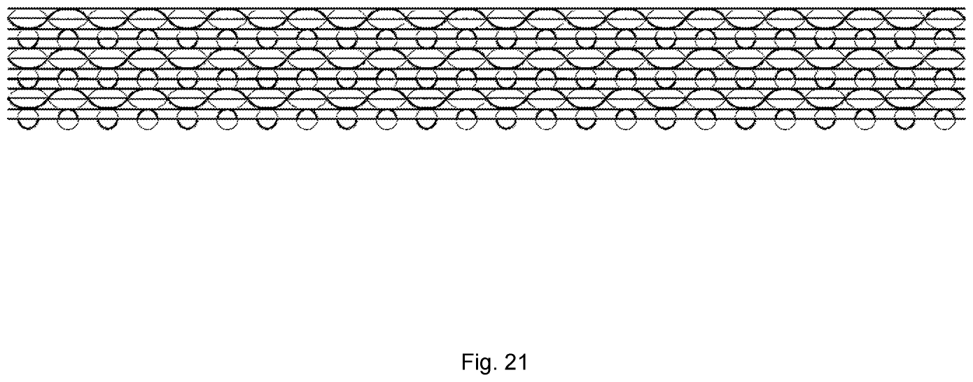

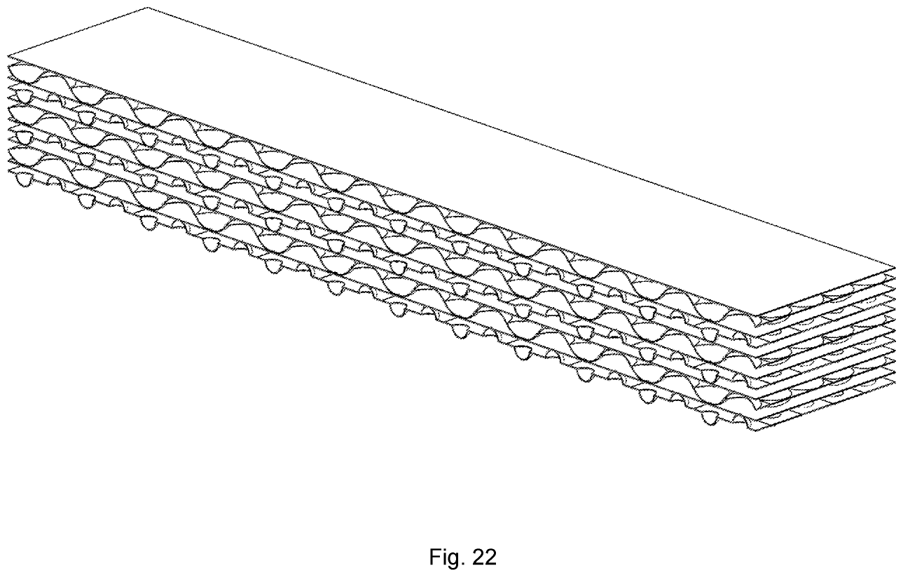

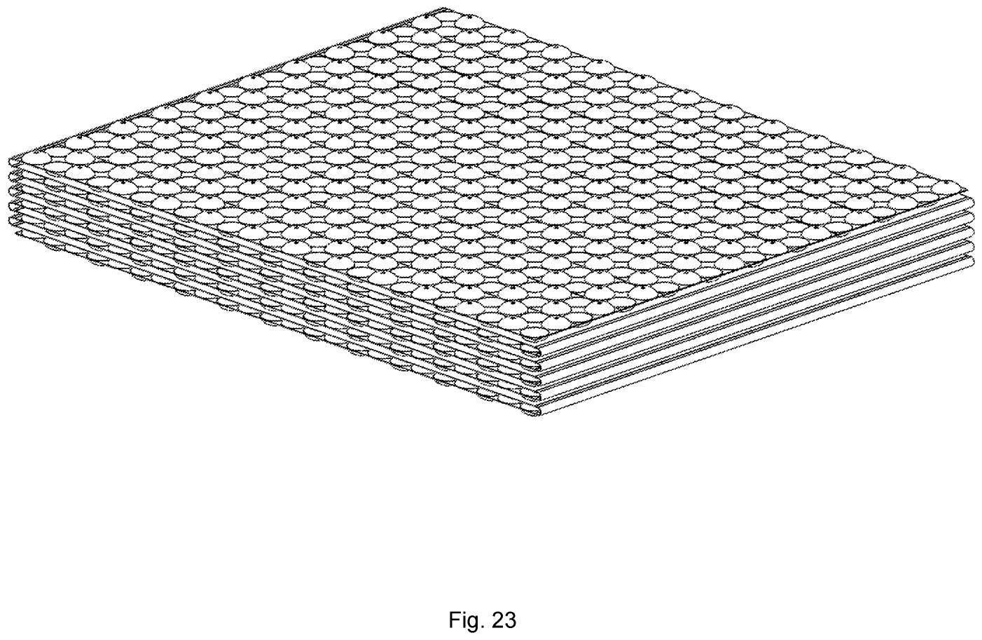

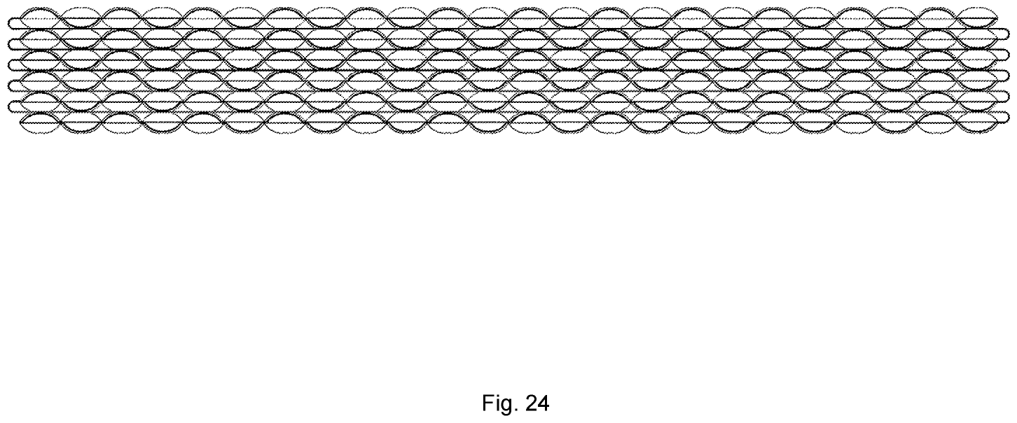

In some embodiments, a core structure is constructed from at least a single ply of paper which contains a plurality of protrusions from the surface where the plane of the surface of the ply is substantially parallel to the plane of the surface of the fully assembled packaging panel. In this context, substantially parallel means an angular range of 15 degrees. In the case where the core is constructed from multiple plies, the plies may have different Patterns such as an A, B, and C pattern. The ply or plies may be assembled into a core structure from discrete plies or may be formed into a core structure by folding sections of a single ply such that there are multiple sections of the ply which are substantially parallel to one another. FIG. 20 illustrates a process for constructing a core structure with discrete plies with a similar length. Pattern A, B, and C (2001, 2002, and 2003 respectively), are stacked atop one another to create the core structure. FIG. 21 shows a side view of the core structure with the plies substantially parallel to the plane of the insulating panel. FIG. 22 shows a perspective cross-section view of the same. FIG. 23 shows a core structure created from various patterns, but constructed from a single ply which has been folded to create sections of the ply that are substantially parallel to one another. FIG. 24 is a side view of the same.

By creating a panel from the various configurations of formed and unformed plies, a thermal resistance value, R, may be achieved which is appreciably large as compared to the mass of material used. That is to compare the ratio of thermal resistance to mass of a homogeneous volume of paper with an R value per inch of approximately 4.0 and a density of approximately 1.2 grams per cubic centimeter versus the core structure described herein with an R value per inch of approximately 3.5 and a density of approximately 0.05 grams per cubic centimeter. An insulating panel with an improved R value per unit mass is considered preferable as less material is used, reducing material cost, as well as reducing shipping costs.

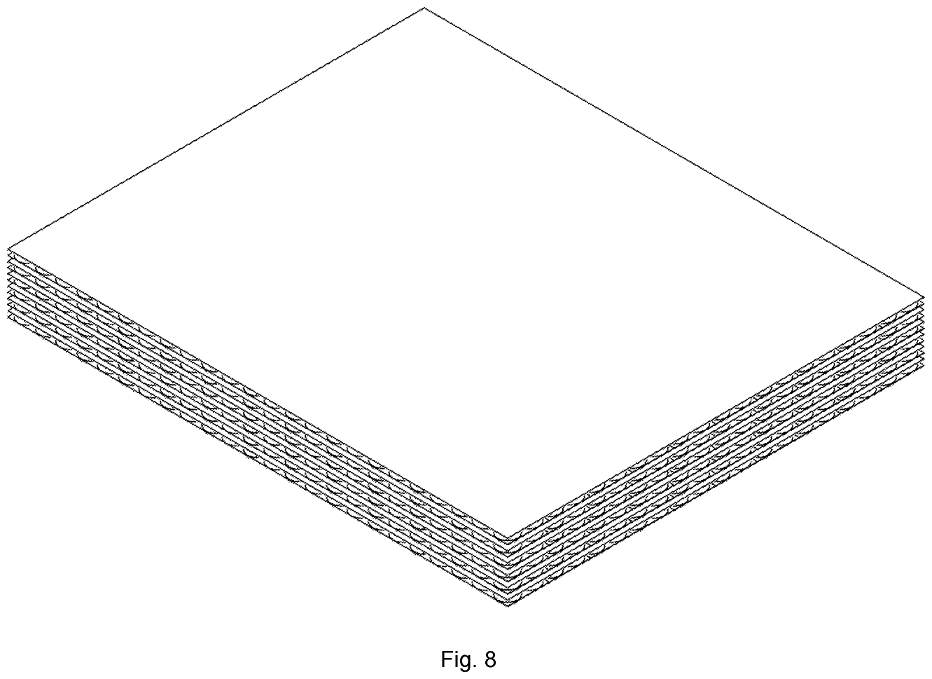

In some embodiments, the outer shell ply(s) do not extend past the core structure in the length direction and or the width direction resulting in the core being visible as shown in FIG. 8.

In some embodiments, the fully assembled insulating panel may contain an outer shell(s) that is segmented or non-continuous, and assembled from multiple pieces which are joined together creating the outer shell(s).

In some embodiments, the adhesive used to adhere the outer shell to the core is a bioplastic material which is biodegradable, and when coupled with the biodegradable paper of the outer shell and core further improves the environmental properties of the panel.

In some embodiments, the fully assembled insulating panel does not require outer shell ply(s) but rather the core structure is made into a panel by adhering the core structure elements to each other by an adhesive, coating, steam, or other mechanical means such as folds, hems, or seams.

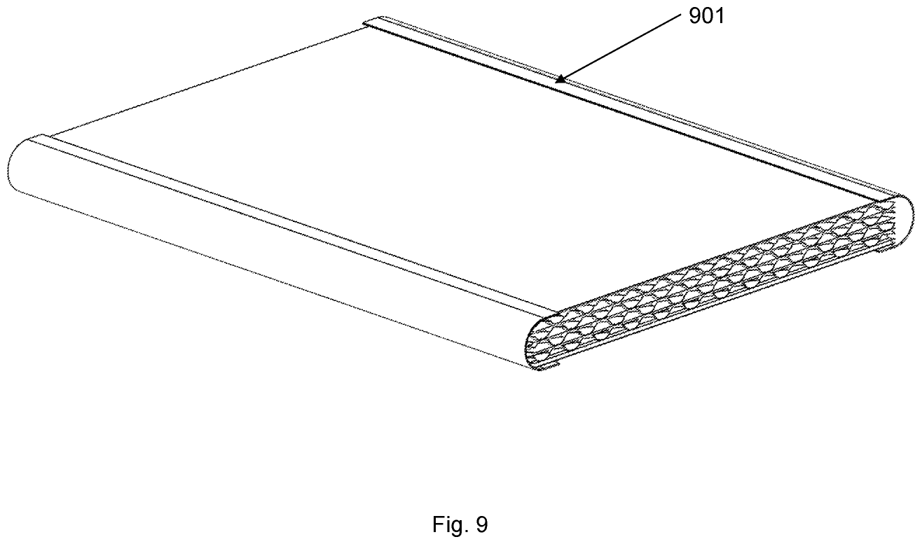

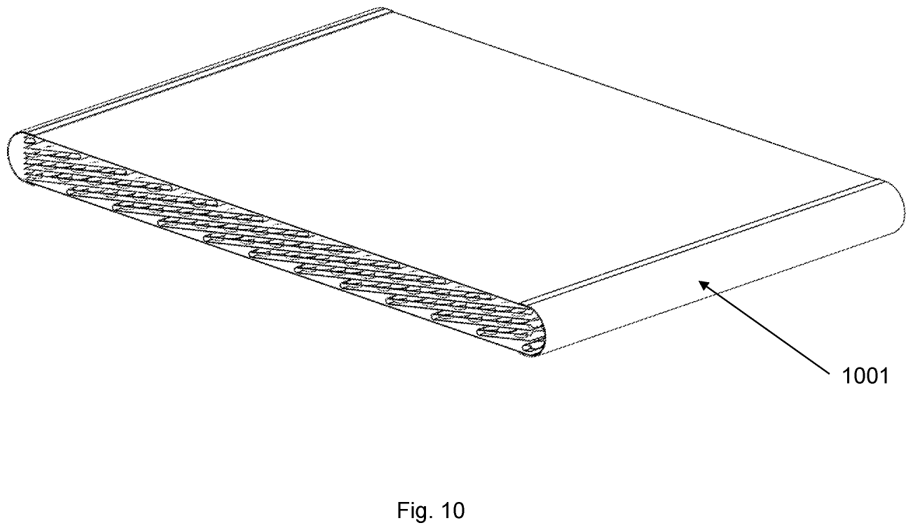

In some embodiments, an additional outer shell ply(s), 901, 1001, as seen in FIGS. 9 and 10, which is smaller than the primary outer shell ply(s), is applied to either the end or one or both sides of the insulating panel to cover the (otherwise exposed) core.

In some embodiments, the core structure within the outer shell(s) comprising the panel has a thickness, a length and a width. The thickness of the panel can be varied to affect the mechanical stiffness of the panel as well as its insulating properties. When the insulating panel is used within a corrugated box as part of a temperature-controlled packaging system, the length, width, and thickness of the panel may be varied to accommodate the dimensions of the corrugated box, the volume available inside of the packaging system for the payload, and the resistance to temperature change inside of the box. The thickness of the panel can be varied primarily by the thickness of the core structure. The thickness of the core structure can be varied by the number of plies, the geometry of the formed protrusions, and/or the ratio of the length of

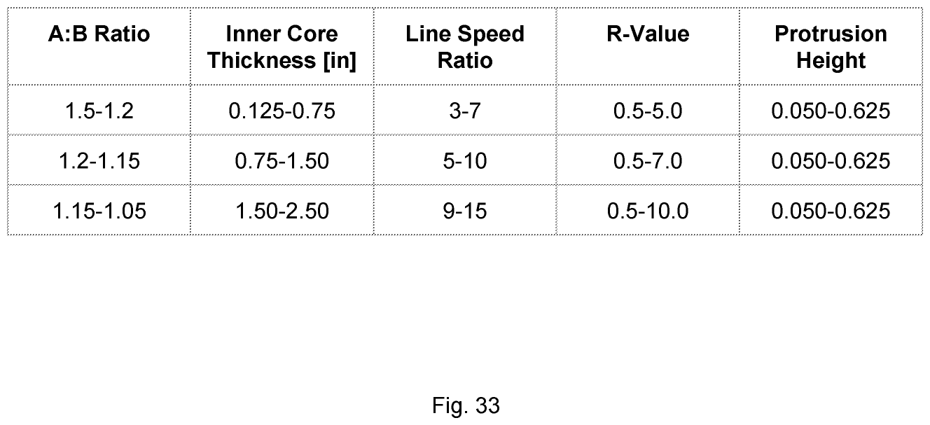

Pattern ‘A’ to Pattern ‘B’, also known as the A:B ratio. FIG. 33 shows a table of potential A:B ratios and their effect on core thickness, the linear ratio of core material to outer shell i.e. the amount of core material required per linear distance of packaging panel, as well as the R value, a measure of thermal conductivity. Additionally examples of protrusions sizes are included.

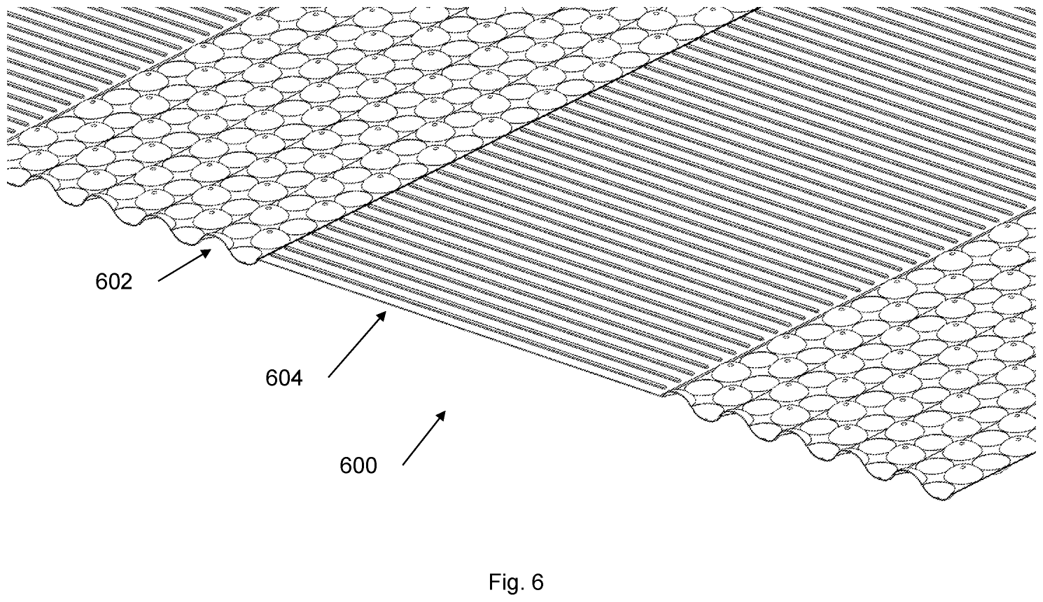

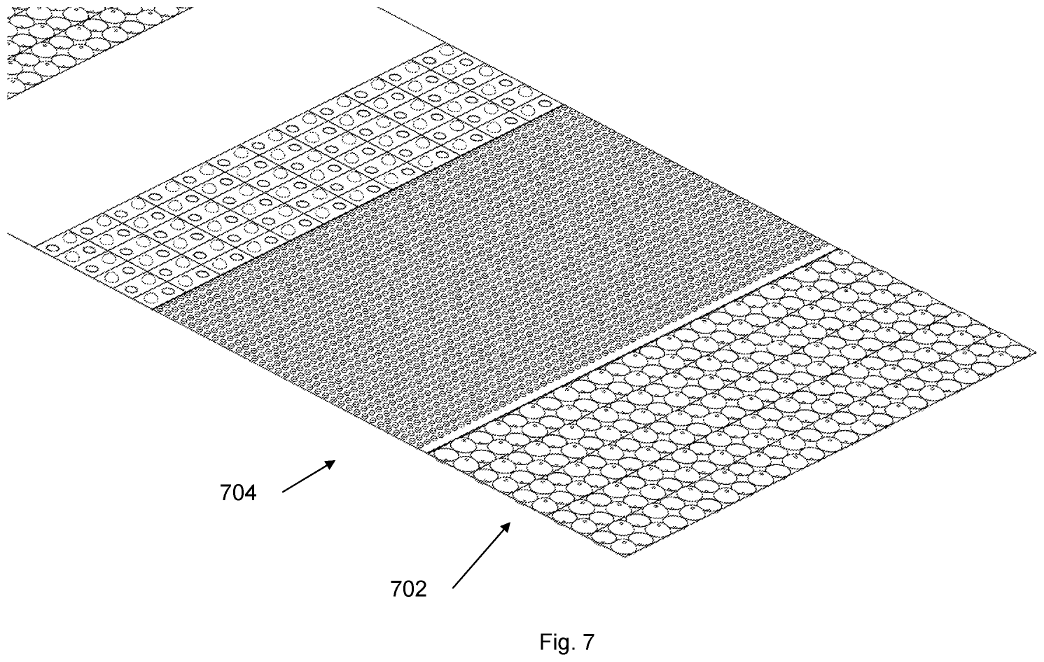

FIG. 6 shows an example of some embodiments where there is an unfolded core ply 600, with formed protrusions in Pattern ‘A’ 602, and a different geometry of formed protrusion in Pattern ‘B’ 604. FIG. 7 is an additional example of a Pattern ‘A’ 702, with an additional design of a Pattern ‘B’ 704.

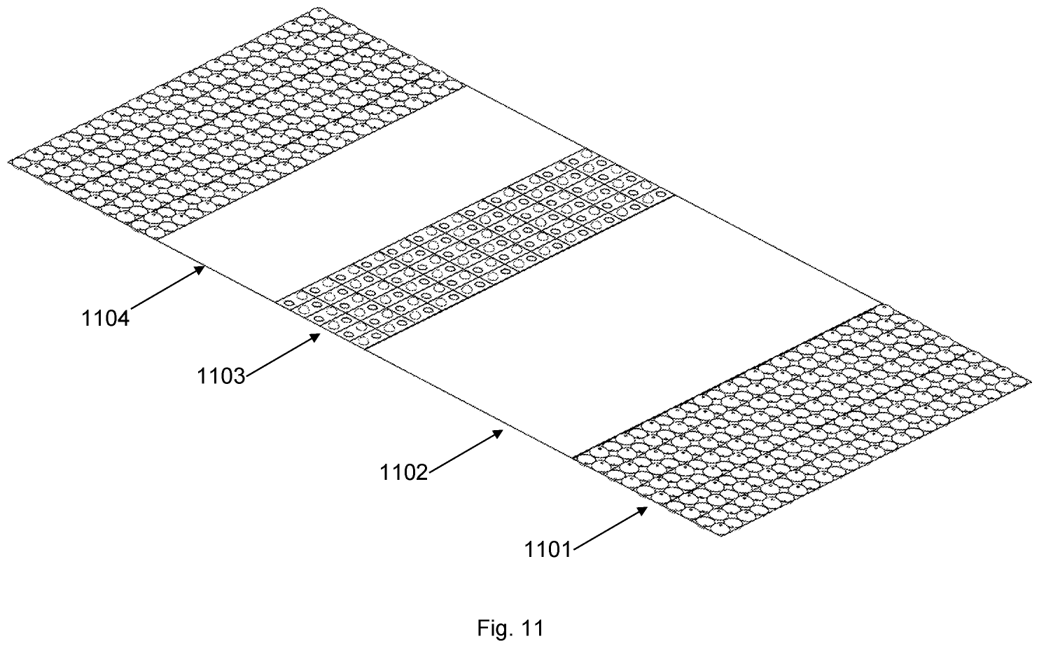

In some embodiments the number of patterns can be greater than two, such as a Pattern ‘A’, “B’, and ‘C’. For example, in FIG. 11 the A, B, C, and D patterns are shown as 1101, 1102, 1103, 1104 respectively. The number of patterns and the ratio of lengths between the patterns can be repeated in a sequence or in a random arrangement based upon the desired thickness along the length of the panel, so long as the ratios and patterns create an core structure.

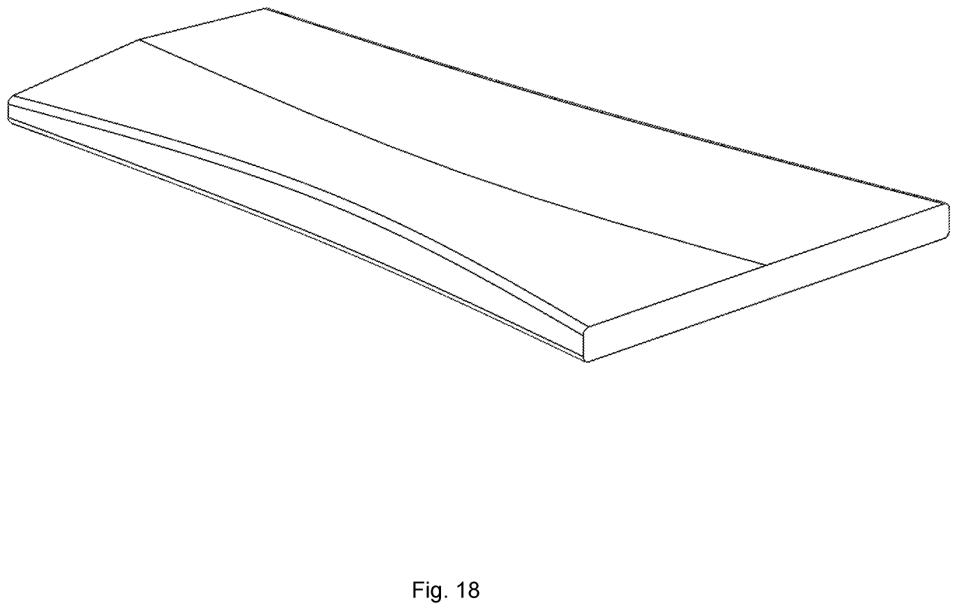

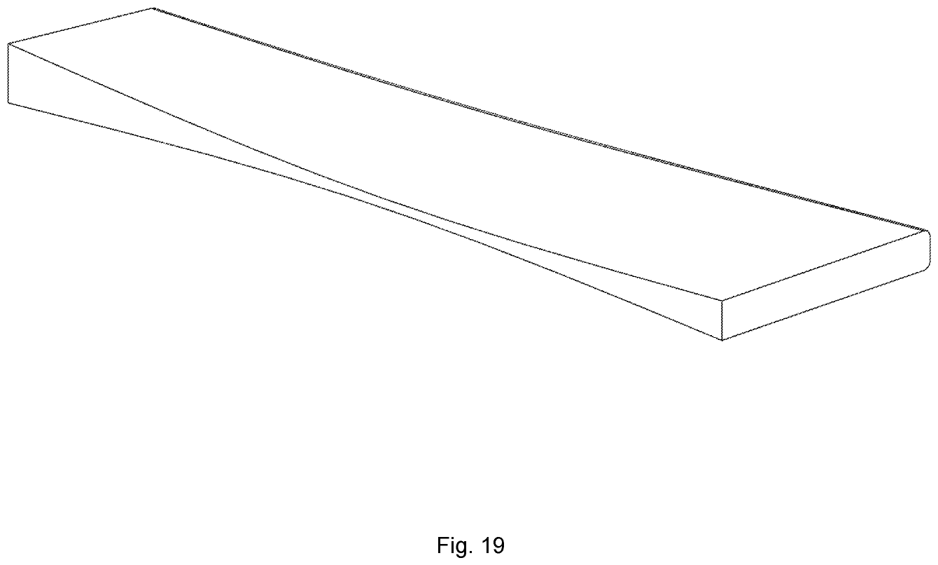

In some embodiments the thickness of the panel may be varied along either the length and/or the width of the insulating panel to achieve a desired insulating performance or conform to a desired shape within the packaging system. FIG. 18 is an example of an insulating panel with a variable thickness and width along the length of the panel. FIG. 19 is a cross-sectional view of the same.

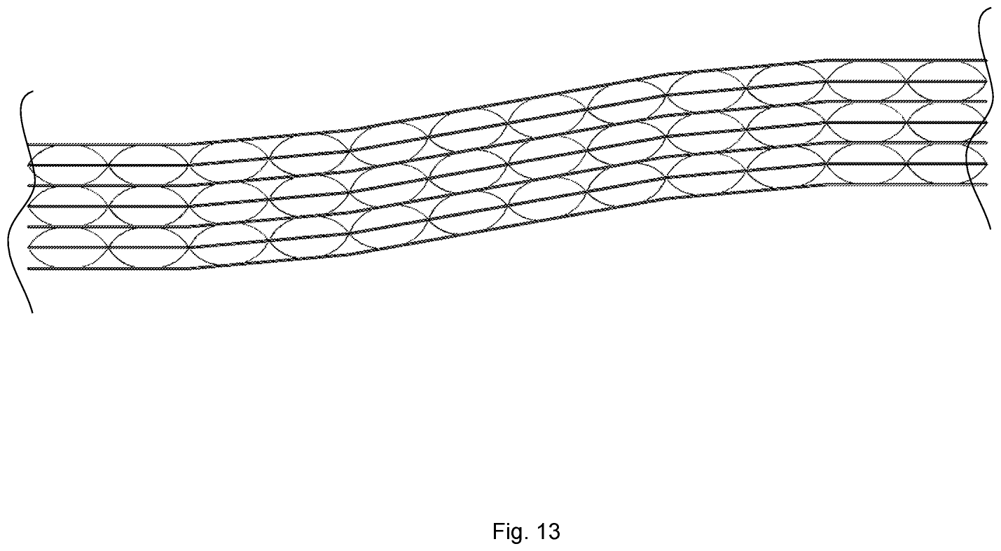

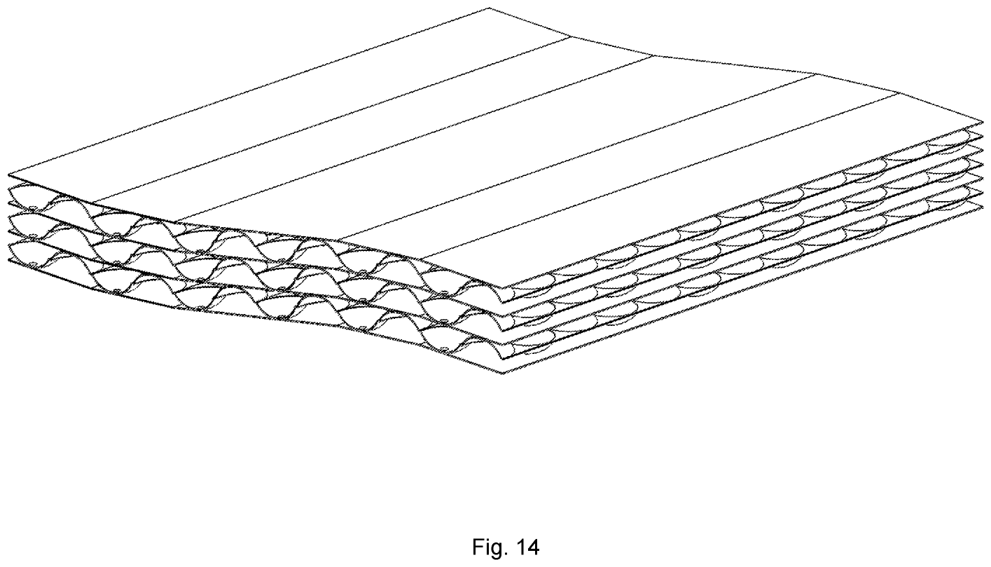

In some embodiments the core layers are non-planar, allowing for the core structure to assume a non-planar shape. In other words, the core structure as a whole can have one or more bends or curves in it. Stated yet another way, the core structure as a whole can occupy different coordinates along an axis parallel to its thickness as one traverses in a direction substantially perpendicular to its thickness. In this context “substantially perpendicular” means parallel to its length or width plus or minus an angular range of 15 degrees. FIG. 13 is a side view of an example of such a non-planar core structure. FIG. 14 shows a cross-sectional view of the non-planar core structure of FIG. 13.

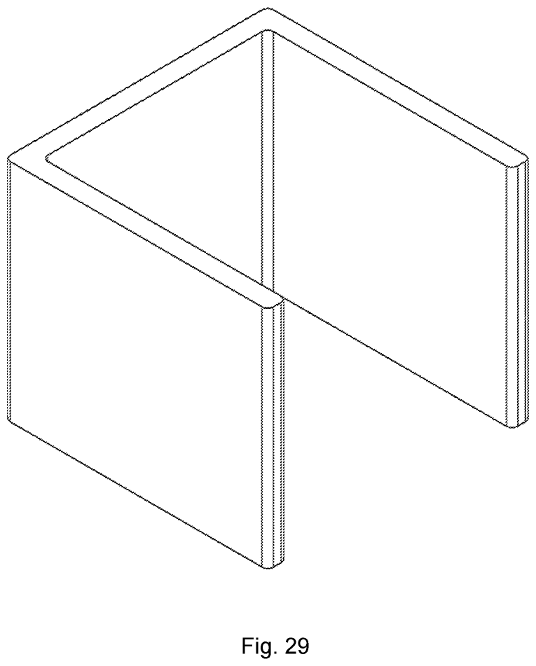

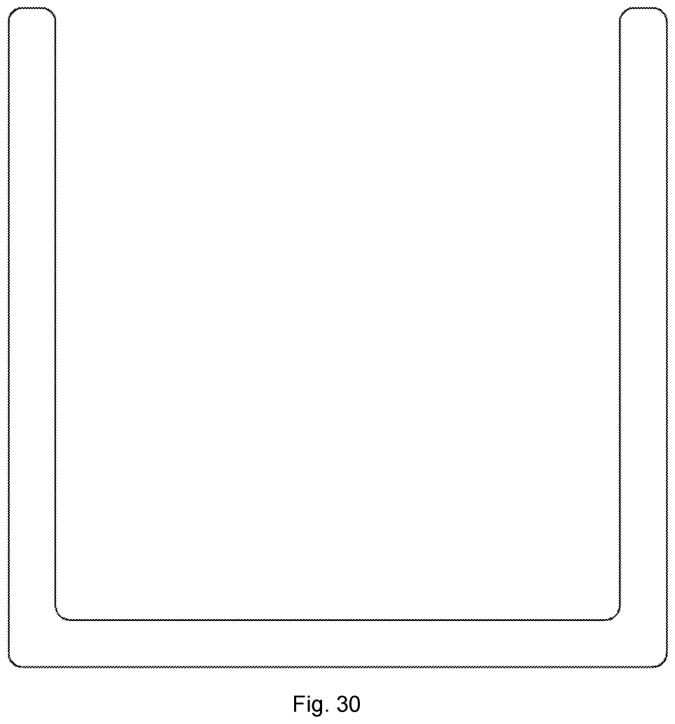

In some embodiments the insulating panel is formed into a semi-rectangular shape to fit inside of a shipping container, as shown in FIG. 29 and FIG. 30.

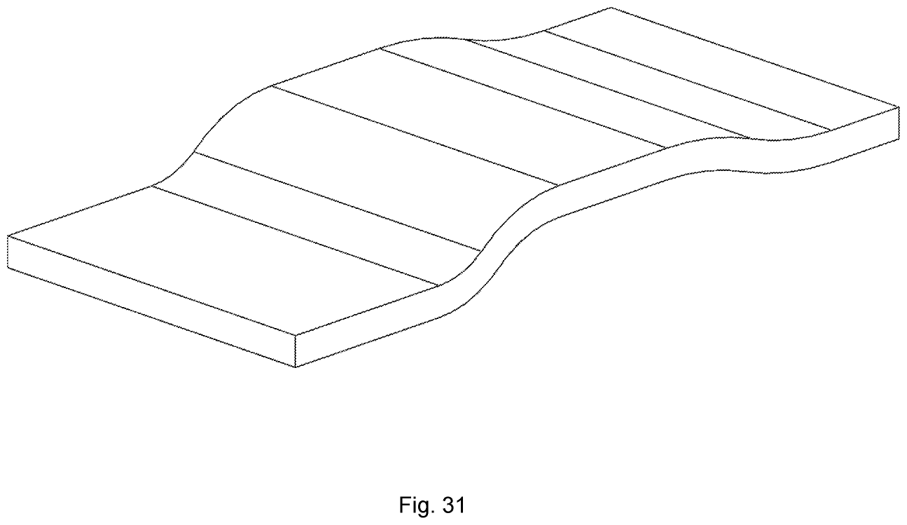

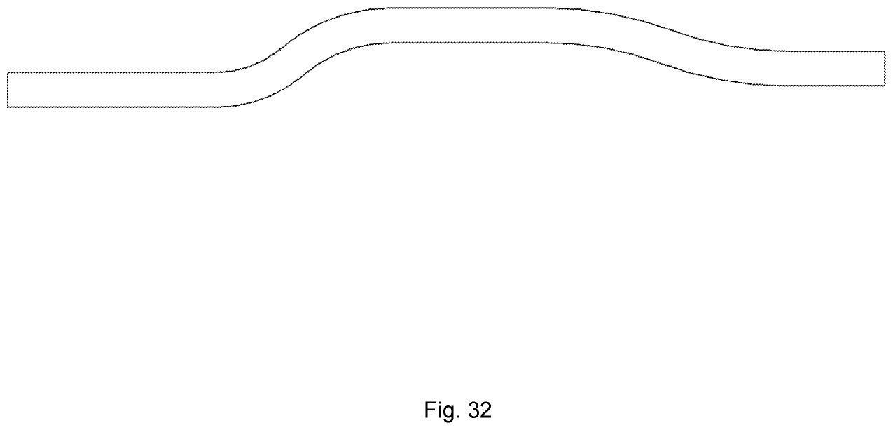

In some embodiments non-planar core layers are used to form a non-planar insulating panel, as shown in FIG. 31 and FIG. 32.

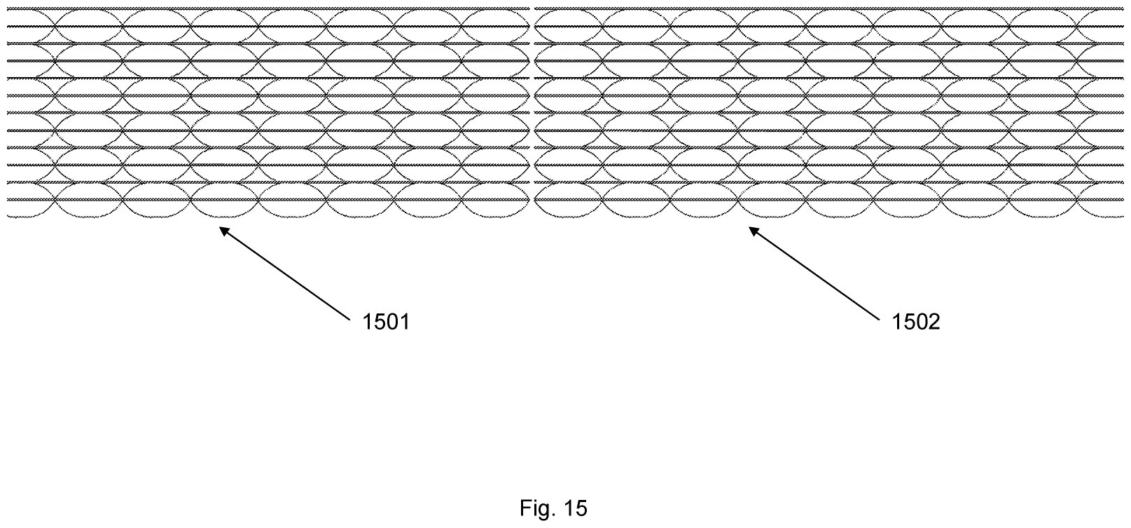

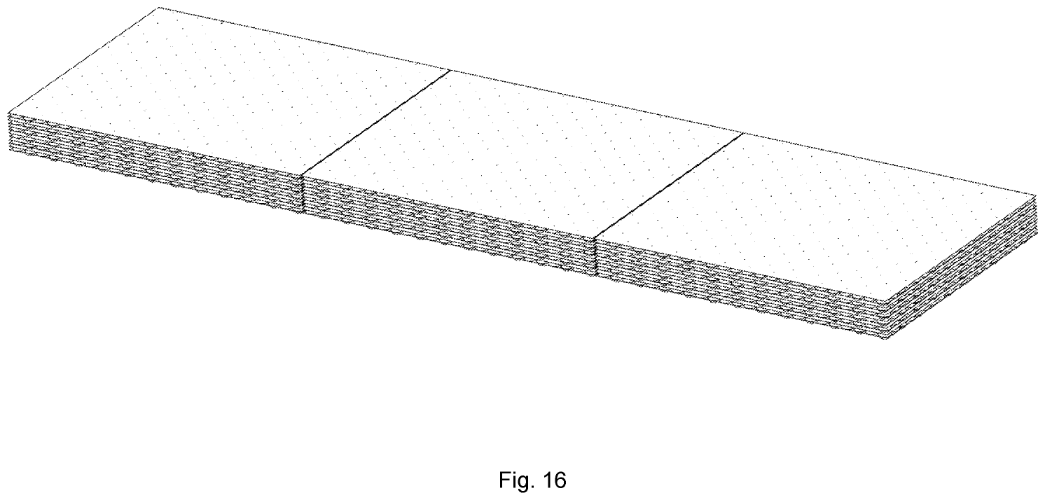

In some embodiments, the fully assembled insulating panel may contain a core structure that is segmented or non-continuous, and assembled from multiple pieces which are joined together creating a core structure. FIG. 15 shows a side view of a core structure, 1501, abutted to another core structure, 1502, such that the gap between the two is negligible in regards to thermal performance. FIG. 16 is an example of multiple core structures situated adjacent to each other to form a larger insulating panel.

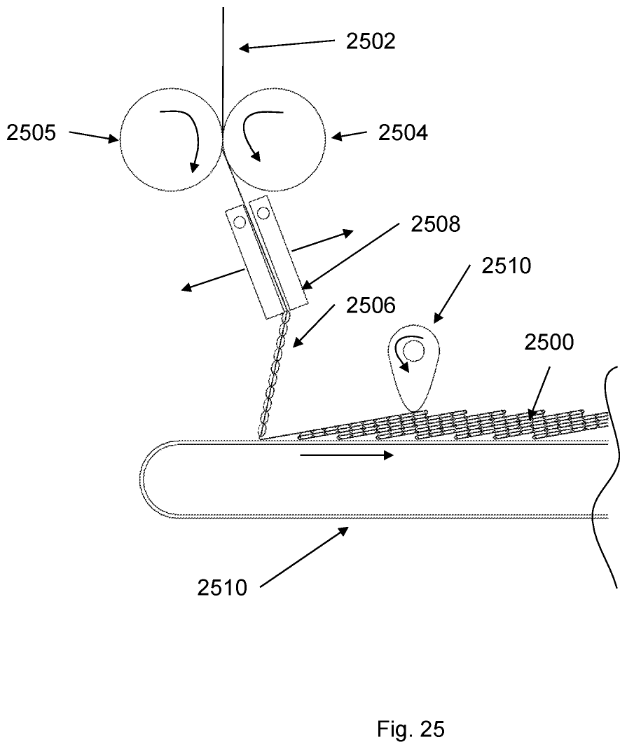

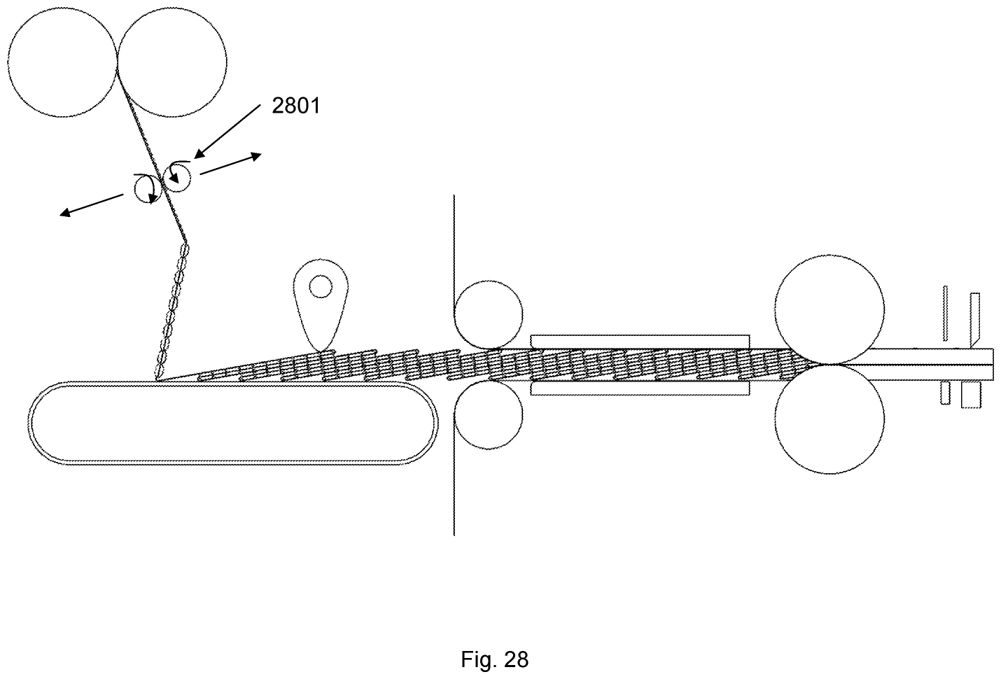

In some embodiments, there is a method for producing the insulating panel which contains an alternating staggered layer core. FIG. 25 shows a process for making the core 2500 from a ply or plies of paper 2502. The ply(s) of paper 2502 are fed between two forming rollers 2504, 2505, which include indentations into the surface of the roller to match the desired Pattern A and Pattern B in the formed ply. The formed ply(s) 2506 is then fed between a set of guides 2508, or driven rollers which can oscillate and if necessary, translate the ply(s), to facilitate the folding of the ply into an undulating staggered structure. FIG. 28 is an example of driven rollers 2801 which can facilitate the feeding of the ply. After the ply is fed through the guides it will contact either a roller, conveyor 2510, outer shell ply, or some other means of translating the core which is moving at a speed to facilitate the staggering of the ply being folded to create the core structure. In some embodiments a cam 2510 can rotate and contact the leading edge of a folded ply to facilitate the consistent folding of the core. The speed of the conveyor 2510 can be geared either mechanically or electronically to the forming rollers 2504 2505, at a ratio of linear speed of ply vs linear speed of assembled core, known as the line speed ratio. The line speed ratio can be set in such a way to create a consistent folding operation of the ply and can be adjusted based on the thickness of the protrusions of the ply and also the Pattern ‘A’ to Pattern ‘B’ ratio, known as the A:B ratio.

In some embodiments, the ply(s) of core paper are formed with a flat die instead of a roller.

In some embodiments, the ply(s) of core paper are formed progressively by feeding the paper through multiple sets of rollers, multiple sets of flat dies, or some combination thereof where the final pattern is formed in more than one step.

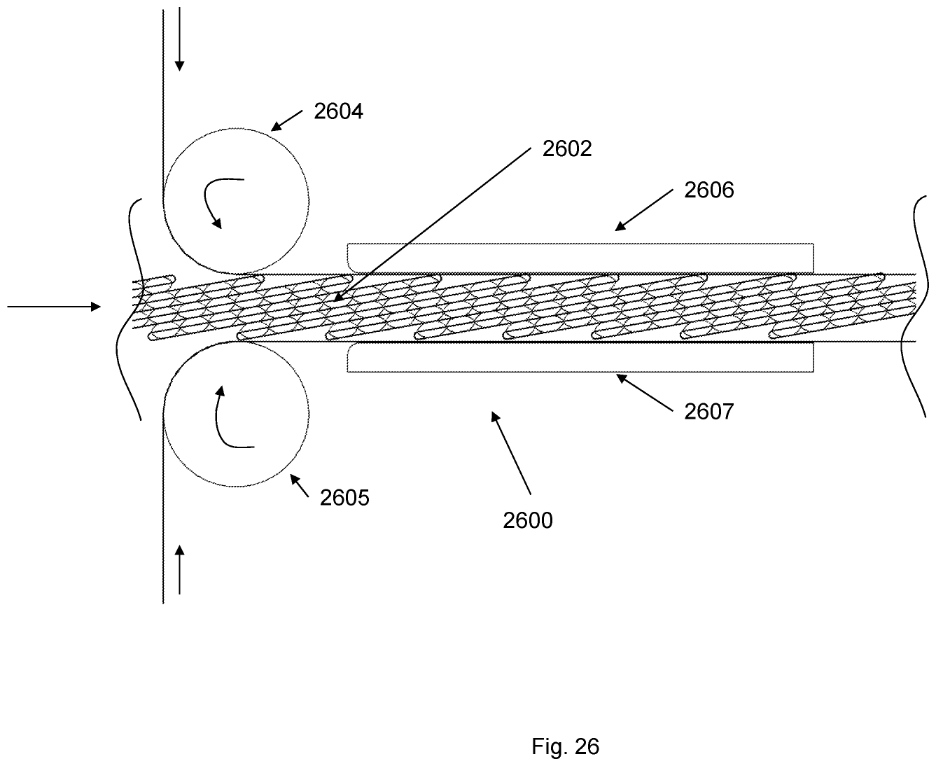

In some embodiments, there is a method for attaching the outer shell to the core structure in a continuous process. FIG. 26 shows a core structure 2602, being continuously fed into the outer shell assembly section 2600. The outer shell assembly section 2600 contains two nip rollers 2604, 2605, which move the top and bottom outer shell layer at the desired speed along the movement of the core structure. The outer shells and core structure are then fed through a top and bottom heater 2606 and 2607, to adhere the outer shells to the core.

In some embodiments, rollers 2604 and 2605 are replaced with guides of any shape to move the outer shell ply(s) to the core. The guides may move/rotate or may be fixed.

In some embodiments, the outer shell ply(s) are wrapped around the core structure.

In some embodiments the outer shell ply(s) are attached to the core by means of an adhesive.

In some embodiments the outer shell ply(s) are attached to the core by means of a steam process.

In some embodiments the outer shell ply(s) are attached to the core by mechanical means such as a fold, hem or similar method.

In some embodiments, the outer shell and core structure are assembled in a non-continuous, discrete process.

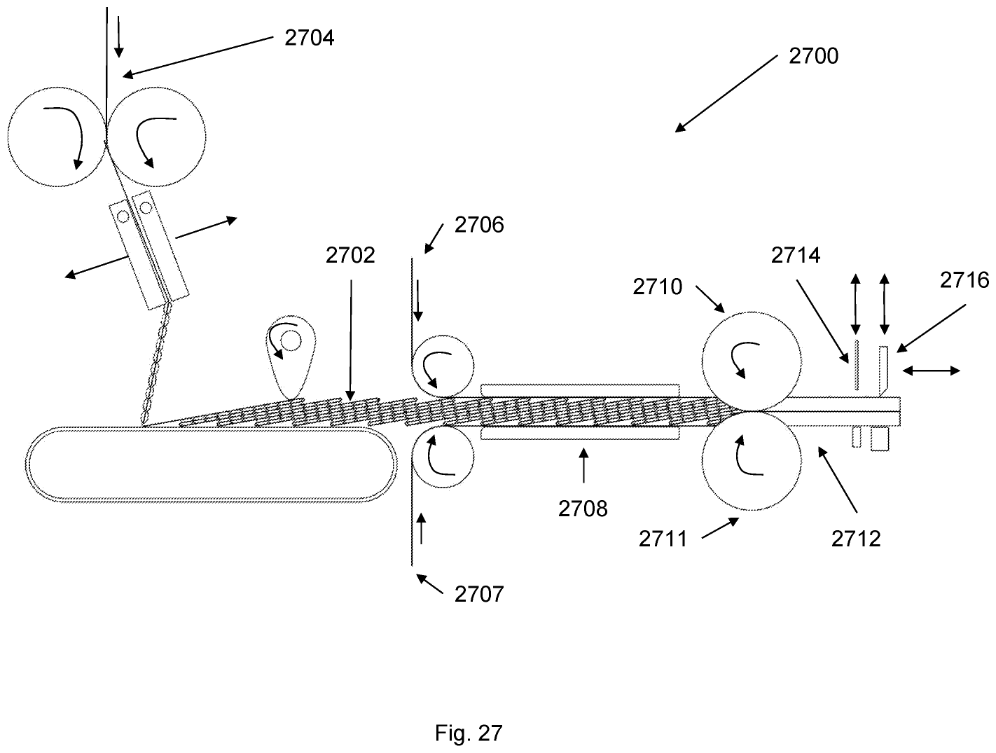

In some embodiments, there is a method for making a fully assembled insulating panel which contains an alternating staggered layer core. FIG. 27 shows a process 2700, to construct the core structure 2702 from ply(es) of paper 2704. The core structure is then adhered to the top and bottom outer shell layers 2706 2707 by the heater section 2708. The adhered outer shell layers and core structure can then be fed through a set of side sealing rollers 2710 and 2711, which when the outer shell layers have a greater width than the core, fully encapsulate the core along the edges. The encapsulated panel 2712 can then be fed between a scoring tool 2714 which compresses a thin section of the insulating panel to create a fold line to facilitate easy assembly within a corrugated box. The panel 2712 is then fed between a cutting knife 2716 which can cut the panel to the desired length. The cutting knife can be actuated linearly either normal to the plane of the insulating panel or along the width axis of the panel. Both the scoring tool 2714 and the cutting knife 2716 may move equal to the line speed during operation to facilitate the process to be run at a continuous speed. The scoring tool may be actuated linearly and moved equal to the line speed or be attached to a rotating cylinder which rotates at the proper speed to equal the line speed. All of the elements of the assembling process may be geared either mechanically or electronically to achieve a desired ratio of speeds as prescribed by the line speed ratio.

The above description and drawings are illustrative and are not to be construed as limiting. Numerous specific details are described to provide a thorough understanding of the disclosure. However, in certain instances, well-known details are not described in order to avoid obscuring the description . Further, various modifications may be made without deviating from the scope of the embodiments .

Reference herein to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control. From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A packaging panel comprising a core structure that includes a first ply of paper that has a surface and a plurality of protrusions from the surface, wherein the first ply of paper is folded in an undulating staggered configuration.

2. A packaging panel according to claim 1, wherein the surface has a plurality of regions, at least two of which have a different pattern of protrusions from each other, and wherein the plurality of regions are arranged relative to each other so as to form an alternating pattern of protrusions along the surface of the first ply of paper.

3. A packaging panel according to claim 2, wherein the first ply of paper is folded in the undulating staggered configuration along a plurality of fold lines, and wherein the alternating pattern of protrusions alternates in a direction perpendicular to the fold lines.

4. A packaging panel according to claim 2, wherein the first ply of paper is folded in the undulating staggered configuration along a plurality of fold lines, and wherein the alternating pattern of protrusions alternates in a direction parallel to the fold lines.

5. A packaging panel according to claim 2, wherein the plurality of regions includes at least three regions, each having a different pattern of protrusions.

6. A packaging panel according to claim 1, wherein each protrusion of the plurality of protrusions includes an empty volume.

7. A packaging panel according to claim 1, further comprising a first outer shell including a second ply of paper attached to the core structure.

8. A packaging panel according to claim 7, where the outer shell is adhered to the core by a bioplastic coating.

9. A packaging panel according to claim 7, further comprising a second outer shell including a third ply of paper attached to the core structure, such that the core structure is disposed between the first outer shell and the second outer shell.

10. A packaging panel according to claim 1, wherein the core structure has a non-planar configuration.

11. A packaging panel according to claim 1, wherein the core structure has a variable width or a variable length.

12. A packaging panel according to claim 1, wherein the core structure has a variable width and a variable length.

13. A packaging panel according to claim 1, wherein the core structure has a variable thickness.

14. A packaging panel comprising:
a core structure including a first ply of paper that has a surface and a plurality of protrusions from the surface, wherein each protrusion of the plurality of protrusions includes an empty volume, the surface having a plurality of regions, at least two of which have a different pattern of protrusions from each other, wherein the plurality of regions are arranged relative to each other so as to form an alternating pattern of protrusions along the surface of the first ply of paper, and wherein the first ply of paper is folded in the undulating staggered configuration along a plurality of fold lines, and wherein the alternating pattern of protrusions alternates in a direction perpendicular to the fold lines;
a first outer shell including a second ply of paper attached to the core structure; and
a second outer shell including a third ply of paper attached to the core structure, such that the core structure is disposed between the first outer shell and the second outer shell.

15. A packaging panel according to claim 14, wherein the plurality of regions includes at least three regions, each having a different pattern of protrusions from each other.

16. A packaging panel according to claim 14, where the outer shell is adhered to the core by a bioplastic coating.

17. A packaging panel according to claim 14, wherein the core structure has a variable width or a variable length.

18. A method of manufacturing a packaging panel, the method comprising:
forming a plurality of protrusions on a surface of first ply of paper, such that the surface has an alternating pattern of protrusions; and
folding the first ply of paper into an undulating staggered configuration, to form at least a portion of a core structure of the packaging panel.

19. A method as recited in claim 18, further comprising:
forming a first outer shell of the packaging panel by attaching a second ply of paper to the core structure.

20. A method as recited in claim 19, wherein the second ply of paper is attached to the core structure by a bioplastic coating.

21. A method as recited in claim 19, further comprising:
forming a second outer shell of the packaging panel by attaching a third ply of paper to the core structure, such that the core structure is disposed between the first outer shell and the second outer shell.

22. A method according to claim 18, wherein each protrusion of the plurality of protrusions includes an empty volume.

23. A packaging panel comprising a core structure that includes a first ply of paper that has a surface and a plurality of protrusions from the surface wherein the core structure is arranged such that a plane of the ply of the core structure is substantially parallel to the plane of the packaging panel.

24. A packaging panel according to claim 23, wherein the core structure comprises a plurality of plies of paper, each having a surface with plurality of protrusions therefrom.

25. A packaging panel according to claim 23, wherein the core structure comprises an additional ply of paper, wherein the additional ply has a surface with no protrusions therefrom.

26. A packaging panel according to claim 23, wherein the core structure comprises a plurality of additional plies of paper, wherein a first one of the additional plies has a first surface and a plurality of protrusions therefrom, and wherein a second one the additional plies has a second surface with no protrusions therefrom.

27. A packaging panel according to claim 23, wherein the first ply of paper is folded to create a core structure in which folded sections of the first ply of paper remain substantially parallel to each other.

28. A packaging panel according to claim 23, further comprising a first outer shell including a second ply of paper attached to the core structure.

29. A packaging panel according to claim 28, further comprising a second outer shell including a third ply of paper attached to the core structure, such that the core structure is disposed between the first outer shell and the second outer shell.
